(19) United States
(12) Patent Application Publication
(10) Pub. No.: US 2026/0355882 A1
(43) Pub. Date: Nov. 12, 2026

(54) WORKPIECE PARALLEL ALIGNMENT SYSTEM AND MACHINE TOOL

(71) Applicant: OKUMA CORPORATION, Niwa-gun (JP)

(72) Inventors: Takuya HONZU, Niwa-gun (JP); Wataru SEGAWA, Niwa-gun (JP)

(73) Assignee: OKUMA CORPORATION, Niwa-gun (JP)

(21) Appl. No.: 19/647,016

(22) Filed: Apr. 14, 2026

(30) Foreign Application Priority Data
May 9, 2025 (JP) 2025-078955

(51) Int. Cl. B23Q 3/18

(52) U.S. Cl. CPC B23Q 3/186

(57) ABSTRACT

A workpiece parallel alignment system includes a table-side positioning portion, a pallet-side positioning portion, a pair of guided portions, and a pair of parallel alignment devices. A pallet is installed on a table by engaging the table-side positioning portion with the pallet-side positioning portion. The guided portions are disposed adjacent to both ends in a right-left direction in a front end side of a lower surface of the pallet. The parallel alignment devices include guide portions engageable with the guided portions and are adjacent to both ends in a right-left direction in a front end side on an upper surface of the table. The guide portions are movable in front-rear direction by guiding drive shafts. Relative movement of the pair of guide portions in a state where the guide portions and the guided portions are engaged adjusts a parallelism between a predetermined reference plane and a reference direction.

### CROSS REFERENCE TO RELATED APPLICATION

This application claims the benefit of Japanese Patent Application Number 2025-078955 on May 9, 2025, the entirety of which is incorporated by reference.

### FIELD OF THE INVENTION

The disclosure relates to a workpiece parallel alignment system that aligns a reference plane of a workpiece placed on a pallet and a reference direction in a machine tool in parallel, and the machine tool.

### BACKGROUND OF THE INVENTION

In a machine tool, in order to achieve objects such as improvement in productivity and reduction in labor costs by automation in executing machining a workpiece as a machining target placed on a pallet, an automatic pallet changer (hereinafter referred to as APC) is installed in the machine tool in some cases. In addition, using the APC, a pallet on which the workpiece is placed in a setup station side is changed with a pallet in the machine tool in some cases.

Workpiece machining under numerical control using a machine tool is executed based on an origin of a processing coordinate system and reference directions of X, Y, Z. Accordingly, to execute accurate machining, it is necessary that, not only an installation position of the workpiece, but also the reference direction of the machine tool and a reference plane of the workpiece are parallel. However, when the pallets are changed after the workpiece is placed on the pallet in the setup station side as described above, a parallelism after moving into the machine tool is not guaranteed to be accurate even though a parallelism between the reference direction of the machine tool and the reference plane of the workpiece is adjusted to some extent in the setup station side. Therefore, it is possible that the reference direction of the machine tool and the reference plane of the workpiece fail to be in parallel on the changed pallet. When the reference direction of the machine tool and the reference plane of the workpiece fail to be in parallel on the pallet after changing, an operator has needed to manually execute an operation of adjusting the reference direction of the machine tool and the reference plane of the workpiece to be in parallel (hereinafter referred to as parallel alignment operation).

Conventionally, the parallel alignment operation by an operator has been a heavy labor that requires considerable effort because a workpiece as a heavy object is hit with a large hammer or is moved using a hydraulic jack. Therefore, for example, semi-automation by fabricating a dedicated jig setup has also been carried out for the purpose of reducing a load on the operator. However, the parallel alignment operation using the dedicated jig setup requires to use a different jig depending on a shape of a workpiece, and therefore, an operation of changing jigs, which puts a load on the operator, has remained.

A parallel alignment operation using software mannered machine control is sometimes executed, instead of a physical parallel alignment operation by an operator as described above. One example is an operation of rotating coordinate axes by machine control using specified parameters to make the reference direction of the machine tool and the reference plane of the workpiece parallel. However, in this case, two axes move, and therefore, when an axis other than the axes the operator intuitively understands moves, an unintended failure can occur. Furthermore, in composite movement of a plurality of axes, the operation is affected by the slowest axis, and therefore the cutting time may be prolonged. In other words, when the parallel alignment operation that rotates the coordinate axes is employed, even though the APC is introduced for productivity improvement, it is possible that its effect is not achieved. Therefore, depending on a user, a parallel alignment operation based on mechanical elements has been desired for the reason that it can be intuitively operated unlike the software mannered control such as the specified parameters. Achieving an intuitive operation leads to a shortened operation period, which may improve productivity.

JP7569700B discloses an exemplary parallel alignment operation based on mechanical elements.

Specifically, a table of a machine tool is provided with a first positioning pin and a second positioning pin, and a lower surface of a pallet is provided with a first pin receiver and a second pin receiver. In the state where the first positioning pin and the second positioning pin are engaged with the first pin receiver and the second pin receiver, respectively, a parallelism adjustment portion moves the second positioning pin in an adjustment direction. Thus, the pallet turns about the first positioning pin, and the parallelism of the workpiece is adjusted.

However, the parallel alignment disclosed in JP7569700B rotates the pallet by pressing of the second pin receiver by the second positioning pin with respect to the rotational center, that is, only one point of effort. Accordingly, the larger the workpiece size becomes, the larger the load on the parallelism adjustment portion becomes. Therefore, when the output of the parallelism adjustment portion is attempted to be increased, the drive unit tends to become large. As a result, there have been issues of an increased size of the whole device and a decreased size of a working space.

Therefore, it is an objective of the disclosure to provide a workpiece parallel alignment system that is installable in a small space and allows for automatically adjusting a parallelism between a reference direction of the machine tool and a reference plane of a workpiece, and a machine tool.

### SUMMARY OF THE INVENTION

In order to solve the above-described issues, a first configuration of the disclosure is a workpiece parallel alignment system. The workpiece parallel alignment system allows for adjusting a parallelism between a predetermined reference plane of a workpiece placed on a pallet and a predetermined reference direction of a machine tool in the machine tool including a table on which the pallet is placeable. The workpiece parallel alignment system includes a table-side positioning portion, a pallet-side positioning portion, a pair of guided portions, and a pair of parallel alignment devices. The table-side positioning portion is disposed at a predetermined position on an upper surface of the table for positioning the pallet. The pallet-side positioning portion is disposed at a predetermined position on a lower surface of the pallet and is engageable with the table-side positioning portion. The pallet is installed on the table by engaging the table-side positioning portion with the pallet-side positioning portion. The pair of guided portions are disposed adjacent to both ends in a right-left direction in a front end side of the lower surface of the pallet, assuming that a side in which the table-side positioning portion and the pallet-side positioning portion are disposed as a rear side in a state where the pallet is installed on the table. The pair of parallel alignment devices include guide portions engageable with the guided portions and are adjacent to both ends in a right-left direction in a front end side on the upper surface of the table. The guide portions are movable in a front-rear direction by guiding drive shafts disposed in the parallel alignment devices. Relative movement of the pair of guide portions in a state where the guide portions and the guided portions are engaged adjusts the parallelism between the reference plane and the reference direction.

In another aspect of the first configuration of the disclosure, which is in the above-described configuration, a guide surface that inclines at a predetermined angle in a right-left direction is formed in the guide portion, and a guided surface that inclines at a predetermined angle in a right-left direction is disposed in the guided portion in an engageable manner with the guide surface.

In another aspect of the first configuration of the disclosure, which is in the above-described configuration, when the pallet is changed, the guiding drive shaft separates the guide portion from the guided portion, and moves the guide portion to a retreat position where the guide portion does not interfere with the pallet change.

In order to solve the above-described issues, a second configuration of the disclosure is a machine tool. The machine tool includes a table on which a pallet is placeable and machines a workpiece placed on the pallet. The machine tool includes a table-side positioning portion, a pallet-side positioning portion, a pair of guided portions, and a pair of parallel alignment devices. The table-side positioning portion is disposed at a predetermined position on an upper surface of the table for positioning the pallet. The pallet-side positioning portion is disposed at a predetermined position on a lower surface of the pallet and is engageable with the table-side positioning portion. The pallet is installed on the table by engaging the table-side positioning portion with the pallet-side positioning portion. The pair of guided portions are disposed adjacent to both ends in a right-left direction in a front end side of the lower surface of the pallet, assuming that a side in which the table-side positioning portion and the pallet-side positioning portion are disposed as a rear side in a state where the pallet is installed on the table. The pair of parallel alignment devices include guide portions engageable with the guided portions and are adjacent to both ends in a right-left direction in a front end side on the upper surface of the table. The guide portions are movable in a front-rear direction by guiding drive shafts disposed in the parallel alignment devices. Relative movement of the pair of guide portions in a state where the guide portions and the guided portions are engaged adjusts a parallelism between a predetermined reference plane of the workpiece and a predetermined reference direction of the machine tool.

In another aspect of the second configuration of the disclosure, which is in the above-described configuration, a guide surface that inclines at a predetermined angle in a right-left direction is formed in the guide portion, and a guided surface that inclines at a predetermined angle in a right-left direction is disposed in the guided portion in an engageable manner with the guide surface.

In another aspect of the second configuration of the disclosure, which is in the above-described configuration, when the pallet is changed, the guiding drive shaft separates the guide portion from the guided portion, and moves the guide portion to a retreat position where the guide portion does not interfere with the pallet change.

With the disclosure, in the parallel alignment system and the machine tool, the pair of parallel alignment devices cause the guide portions to relatively move to press the pair of guided portions of the pallet, and thus, the pallet turns, and the parallelism between the reference direction of the machine tool and the reference plane of the workpiece is automatically adjusted. Accordingly, the relative movement of the guide portions in the parallel alignment device executes parallel alignment, and therefore, loads on the respective parallel alignment devices are reducible. Accordingly, the driving source of the parallel alignment device can be downsized, which allows for contribution to compactification of the double column machining center and securing of the working space. In addition, the parallel alignment device is separated from the working space by the pallet, which allows for inhibiting impurities, such as cutting water or chips, generated by machining of the workpiece from getting into the parallel alignment device, and therefore, occurrence of a failure is reducible.

Furthermore, the guide surface that inclines in the right-left direction is formed in the guide portion, and the guided surface that inclines in the right-left direction is disposed in the guided portion in an engageable manner with the guide surface. Accordingly, when the guide portions are relatively moved during the parallel alignment operation, the guide surfaces and the guided surfaces smoothly move, and therefore, the pallet is rotatable with a small output. Accordingly, the parallel alignment device can be downsized, which allows for contribution to compactification of the double column machining center and securing of the working space.

When the pallet is changed, the guiding drive shaft separates the guide portion from the guided portion, and moves the guide portion to the retreat position where the guide portion does not interfere with the pallet change. Accordingly, the parallel alignment device does not affect the automatic pallet change by the APC. Therefore, the pallet is smoothly changed, thereby allowing for improving productivity.

### BRIEF DESCRIPTION OF THE DRAWINGS

FIG. 1 is an explanatory drawing illustrating a relation between a workpiece, a pallet, and a table in the state where parallel alignment has not been performed.

FIG. 2 is an explanatory drawing illustrating an outline of a workpiece parallel alignment system.

FIG. 3 is an explanatory drawing illustrating a relation between the workpiece, the pallet, and the table in the state where parallel alignment has been performed.

FIG. 4 is an explanatory drawing illustrating the workpiece parallel alignment system with guiding portions having moved to retreat positions.

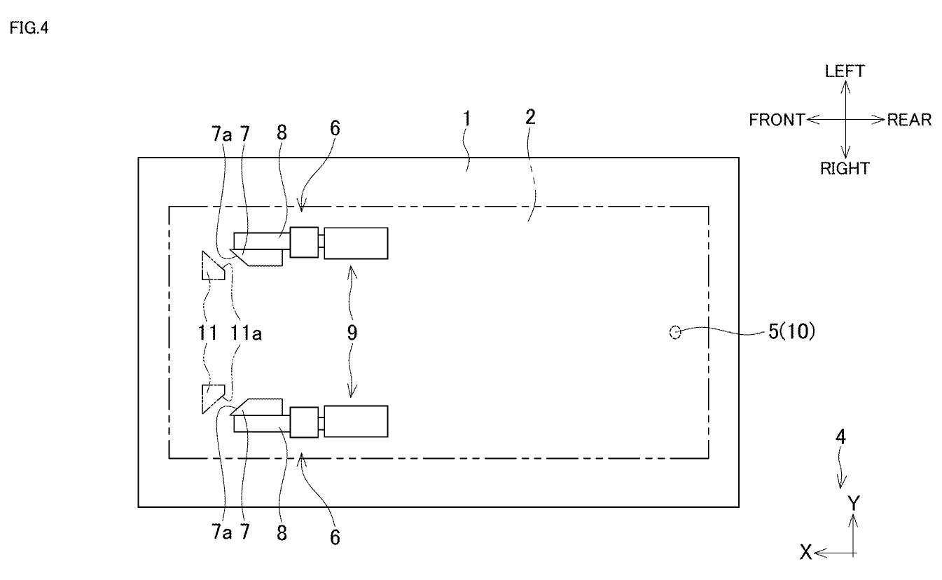

### DETAILED DESCRIPTION OF THE INVENTION

The following describes embodiments of the disclosure based on the drawings.

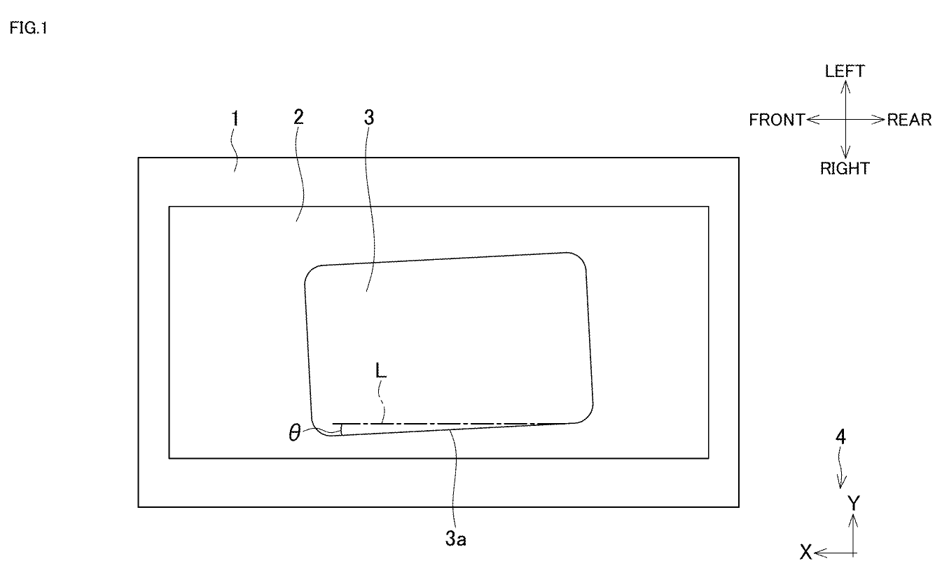

A double column machining center as a machine tool includes a table 1 in a machining room. The double column machining center includes an APC. Accordingly, the double column machining center continuously machines a workpiece 3 placed on a pallet 2, while changing the pallet 2 between a setup station side and the machining room. When a right-side surface of the workpiece 3 having a rectangular shape in top view is defined as a reference plane 3a, a reference direction 4 of the double column machining center and the reference plane 3a of the workpiece 3 may not be in parallel on the pallet 2 conveyed into the machining room by the APC, as illustrated in FIG. 1. Specifically, the state illustrated in FIG. 1 is a state where the parallelism between the reference plane 3a and an X-axis of the reference direction 4 are displaced by an inclination θ. A one dot chain line L in FIG. 1 is a line segment parallel to the X-axis.

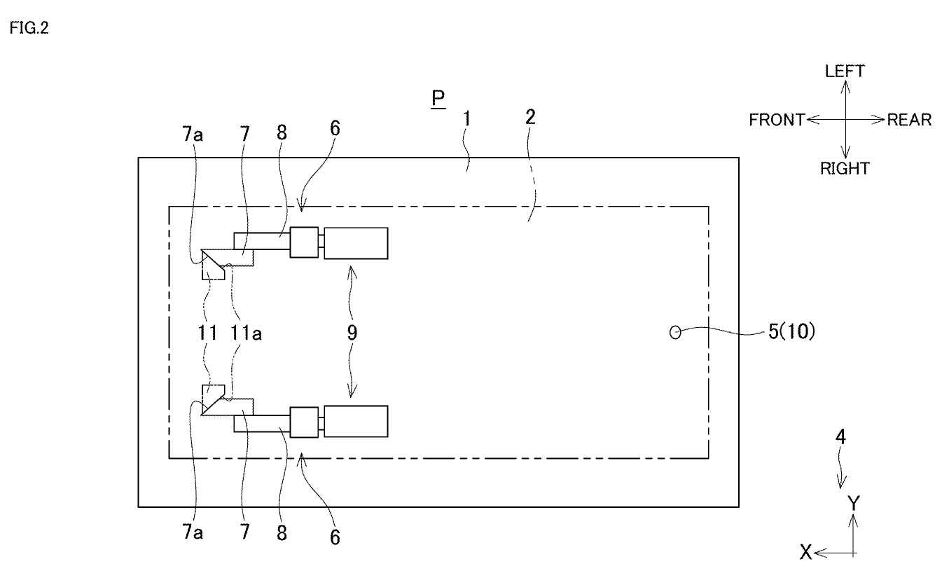

As illustrated in FIG. 2, a parallel alignment system P includes a positioning pin 5 positioning the pallet 2 at a predetermined position and a pair of parallel alignment devices 6 that are disposed on an upper surface of the table 1, and a pin receiver 10 engageable with the positioning pin 5 and a pair of guided portions 11 that are disposed on a lower surface of the pallet 2.

The positioning pin 5 is a protrusion arranged at a center in the right-left direction in a rear end side of the table 1 as illustrated in FIG. 2. One example of the positioning pin 5 is a cylindrical protrusion. On the other hand, the pin receiver 10 is a recess arranged at a center in the right-left direction in a rear end side of the pallet 2. One example of the pin receiver 10 is a circular-shaped recess. When the pallet 2 is placed on the table 1 in the setup station side, the positioning pin 5 is inserted into the pin receiver 10 to make an engagement, so that the pallet 2 is positioned with respect to the table 1. A clearance is provided between the positioning pin 5 and the pin receiver 10 sufficient to allow the pallet 2 to rotate about the pin receiver 10, eventually, the positioning pin 5. For example, the pin receiver 10 is a recess having an inner diameter slightly larger than an outer diameter of the positioning pin 5. The positioning pin 5 is a table-side positioning portion in the disclosure, and the pin receiver 10 is a pallet-side positioning portion. The pin receiver 10 may have an inclination upwardly tapered off or may be in another shape as long as the pallet 2 is rotatable about the pin receiver 10.

The pair of parallel alignment devices 6 are arranged in a front end side of the table 1 and adjacent to a left edge and adjacent to a right edge, respectively, as illustrated in FIG. 2. The parallel alignment device 6 includes a guide portion 7, a ball screw 8, and a motor 9. The guide portion 7 has a front surface on which a guide surface 7a inclining leftward or rightward is formed. In the disclosure, the left-side guide portion 7 has the guide surface 7a inclining leftward, and the right-side guide portion 7 has the guide surface 7a inclining rightward. The guide portion 7 is mounted on the ball screw 8 movably in a front-rear direction. The ball screw 8 is a guiding drive shaft in the disclosure. The motor 9 is a driving source of the ball screw 8. In the embodiment, the motor 9 includes a detector that can detect a position of the guide portion 7, such as a phase of the ball screw 8, and incidental equipment, such as a decelerator, for improving an output torque.

The pair of guided portions 11 are arranged at respective positions adjacent to a left edge and adjacent to a right edge in a front end side on the lower surface of the pallet 2, and engageable with the guide portions 7 of the parallel alignment devices 6 as illustrated in FIG. 2. The guided portion 11 has a rear surface on which a guided surface 11a is formed. The guided surface 11a inclines in the right-left direction in accordance with the corresponding guide portion 7 and is engageable with the guide surface 7a.

The following describes a parallel alignment operation during pallet change in the double column machining center including the parallel alignment system P as described above.

In the setup station side, the workpiece 3 is placed on the pallet 2. Continuously, the pallet change by the APC is performed. Thus, the pallet 2 on which the workpiece 3 is placed is conveyed into the machining room of the double column machining center.

The pallet 2 conveyed into the machining room is installed on the table 1. At this time, the positioning pin 5 on the table 1 is inserted into the pin receiver 10 of the pallet 2. The workpiece 3 on the conveyed pallet 2 is assumed to be such that a parallelism between the X-axis of the reference direction 4 of the double column machining center and the reference plane 3a of the workpiece 3 is displaced by the inclination θ as illustrated in FIG. 1.

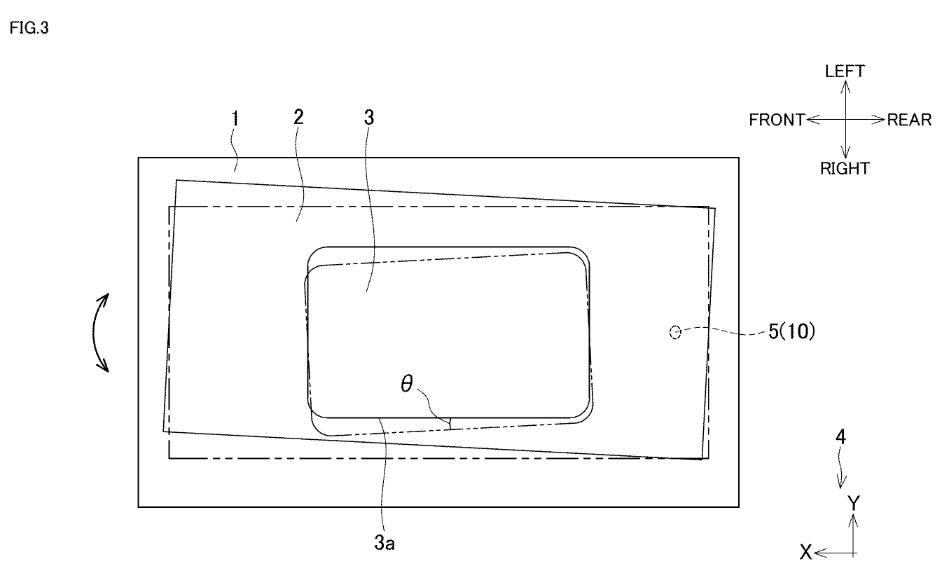

To correct the displacement of the inclination θ, and make the X-axis of the reference direction 4 of the double column machining center and the reference plane 3a of the workpiece 3 parallel, the ball screws 8 of the parallel alignment devices 6 are driven to cause the guide portions 7 to move forward. The guide portions 7 that have moved forward are engaged with the guided portions 11 of the pallet 2. The guide portions 7 are relatively moved from the state where the guide portions 7 on both the right and left sides are engaged with the guided portions 11, thereby the pallet 2 rotates about the pin receiver 10 from the pre-adjustment state indicated by the two-dot chain line as indicated by the double-headed arrow in FIG. 3. As indicated by the solid line in FIG. 3, the movement of the guide portions 7 is stopped at the position where the pallet 2 rotates by the inclination θ, and where the reference plane 3a of the workpiece 3 is brought into parallel to the reference direction 4 of the double column machining center. The parallel alignment device 6 includes a clamp mechanism (not illustrated), which fixes the guide portion 7 at the stop position. Thus, the workpiece 3 is fixable in the posture aligned in parallel.

As described above, in the parallel alignment system P, the pair of parallel alignment devices 6 cause the guide portions 7 to relatively move to press the pair of guided portions 11 of the pallet 2, and thus, the pallet 2 turns and the parallelism between the reference direction 4 of the double column machining center and the reference plane of the workpiece 3 is automatically adjusted.

At this time, parallel alignment is performed by the relative movement of the guide portions 7 of the parallel alignment devices 6, and therefore, the loads on the respective parallel alignment devices 6 are reducible. Furthermore, the guide surface 7a inclining in the right-left direction is formed in the guide portion 7, and the guided surface 11a that inclines in the right-left direction is disposed in the guided portion 11 in an engageable manner with the guide surface 7a, and therefore, the guide surfaces 7a and the guided surfaces 11a move smoothly even though the guide portions 7 are caused to relatively move during the parallel alignment operation, and the pallet 2 is rotatable with a small output. Accordingly, the parallel alignment device 6 can be downsized, which allows for contribution to compactification of the double column machining center and securing of the working space. Since the position of the guide portion 7 is controllable based on the information, such as the phase of the ball screw 8 detected in the motor 9, parallel alignment by the mechanical element is automatically performable. In addition, the parallel alignment device 6 is separated from the working space by the pallet 2, which allows for inhibiting impurities, such as cutting water or chips, generated by machining of the workpiece 3 from getting into the parallel alignment device 6, and therefore, occurrence of a failure is reducible.

Note that, when the pallet is changed, the ball screws 8 separate the guide portions 7 from the guided portions 11, and move the guide portions 7 to the positions where the guide portions 7 do not interfere with installation and carry-out of the pallet 2 by the APC, that is, the retreat positions. Accordingly, the parallel alignment devices 6 do not affect the automatic pallet change by the APC. Therefore, the pallet 2 is smoothly changed, thereby allowing for improving productivity.

In the double column machining center including the table 1 on which the pallet 2 is placeable, the parallel alignment system P for the workpiece 3 constituted as described above includes the positioning pin 5, the pin receiver 10, the pair of guided portions 11, and the pair of parallel alignment devices 6. The positioning pin 5 allows for adjusting the parallelism between the reference plane 3a of the workpiece 3 placed on the pallet 2 and the reference direction 4 of the double column machining center, and positions the pallet 2 in the center in the right-left direction in the rear end side on the upper surface of the table 1. The pin receiver 10 is engageable with the positioning pin 5 in the center in the right-left direction in the rear end side on the lower surface of the pallet 2. The pallet 2 is installed on the table 1 by engaging the positioning pin 5 with the pin receiver 10. The pair of guided portions 11 are adjacent to both the ends in the right-left direction in the front end side on the lower surface of the pallet 2 in the state where the pallet 2 is installed on the table 1. The pair of parallel alignment devices 6 have the guide portions 7 engageable with the guided portions 11 and are adjacent to both the ends in the right-left direction in the front end side on the upper surface of the table 1. The guide portion 7 is movable in the front-rear direction by the ball screw 8 disposed in the parallel alignment device 6, and the relative movement of the pair of guide portions 7 in the state where the guide portions 7 and the guided portions 11 are engaged adjusts the parallelism between the reference plane 3a and the reference direction 4.

Therefore, the loads on the respective parallel alignment devices 6 are reducible. Accordingly, the motor 9 can be downsized, which allows for contribution to compactification of the double column machining center and securing of the working space. Furthermore, the parallel alignment device 6 is separated from the working space by the pallet 2, which allows for inhibiting impurities, such as cutting water or chips, generated by machining of the workpiece 3 from getting into the parallel alignment device 6, and therefore, occurrence of a failure is reducible.

The guide surface 7a inclining in the right-left direction is formed in the guide portion 7, and the guided surface 11a inclining in the right-left direction is disposed in the guided portion 11 in an engageable manner with the guide surface 7a.

Accordingly, even when the guide portions 7 are caused to relatively move during the parallel alignment operation, the guide surfaces 7a and the guided surfaces 11a smoothly move, and therefore, the pallet 2 is rotatable with a small output.

The ball screw 8 separates the guide portion 7 from the guided portion 11 when the pallet 2 is changed, and moves the guide portion 7 to the retreat position where the guide portion 7 does not interfere with the change of the pallet 2.

Accordingly, the parallel alignment devices 6 do not affect the automatic pallet change by the APC. Therefore, the pallet 2 is smoothly changed, thereby allowing for improving productivity.

The configurations relating to the workpiece parallel alignment system and the machine tool according to the disclosure are not at all limited to the aspects described in the above-described embodiment, and may be appropriately changed as necessary within the range not departing from the gist of the disclosure.

For example, the machine tool is not limited to the double column machining center, but may be a machine tool of another kind.

The machine tool does not necessarily need to be equipped with an automatic pallet changer (APC) as long as the machine tool performs machining with a workpiece placed on a pallet.

The installation position of the parallel alignment device on the table upper surface, and the installation position of the guided portion on the pallet lower surface are allowed to be any installation positions as long as the position allows the pallet to rotate with pressing of the guided portion caused by the relative movement of the guide portion.

The shapes of the table-side positioning portion and the pallet-side positioning portion are not limited as long as the pallet is positioned and is engageable in a rotatable manner about the pallet-side positioning portion. For example, the combination of a recessed table-side positioning portion and a protruded pallet-side positioning portion is allowed.

The shapes of the guide portion and the guided portion including the guide surface and the guided surface that incline in the above-mentioned direction are not limited as long as the guide portion and the guided portion can perform the parallel alignment operation by the relative movement of the pair of guide portions.

The description relating to the directions in the above-described embodiment are merely set for describing the parallel alignment system and the machine tool, defining the side where the table-side positioning portion and the pallet-side positioning portion are provided as the rear side in the state where the pallet is installed on the table. Therefore, for example, the rear side in the above-described embodiment may be a direction indicated as the front side in the actual machine tool.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A workpiece parallel alignment system allowing for adjusting a parallelism between a predetermined reference plane of a workpiece placed on a pallet and a predetermined reference direction of a machine tool in the machine tool including a table on which the pallet is placeable, the workpiece parallel alignment system comprising:
a table-side positioning portion disposed at a predetermined position on an upper surface of the table for positioning the pallet;
a pallet-side positioning portion disposed at a predetermined position on a lower surface of the pallet and engageable with the table-side positioning portion, the pallet being installed on the table by engaging the table-side positioning portion with the pallet-side positioning portion;
a pair of guided portions disposed adjacent to both ends in a right-left direction in a front end side of the lower surface of the pallet, assuming that a side in which the table-side positioning portion and the pallet-side positioning portion are disposed as a rear side in a state where the pallet is installed on the table; and
a pair of parallel alignment devices that include guide portions engageable with the guided portions and are adjacent to both ends in a right-left direction in a front end side on the upper surface of the table, the guide portions being movable in a front-rear direction by guiding drive shafts disposed in the parallel alignment devices, wherein
relative movement of the pair of guide portions in a state where the guide portions and the guided portions are engaged adjusts the parallelism between the reference plane and the reference direction.

2. The workpiece parallel alignment system according to claim 1, wherein
a guide surface that inclines at a predetermined angle in a right-left direction is formed in the guide portion, and
a guided surface that inclines at a predetermined angle in a right-left direction is disposed in the guided portion in an engageable manner with the guide surface.

3. The workpiece parallel alignment system according to claim 1, wherein
when the pallet is changed, the guiding drive shaft separates the guide portion from the guided portion, and moves the guide portion to a retreat position where the guide portion does not interfere with the pallet change.

4. A machine tool that includes a table on which a pallet is placeable and machines a workpiece placed on the pallet, the machine tool comprising:
a table-side positioning portion disposed at a predetermined position on an upper surface of the table for positioning the pallet;
a pallet-side positioning portion disposed at a predetermined position on a lower surface of the pallet and engageable with the table-side positioning portion, the pallet being installed on the table by engaging the table-side positioning portion with the pallet-side positioning portion;
a pair of guided portions disposed adjacent to both ends in a right-left direction in a front end side of the lower surface of the pallet, assuming that a side in which the table-side positioning portion and the pallet-side positioning portion are disposed as a rear side in a state where the pallet is installed on the table; and
a pair of parallel alignment devices that include guide portions engageable with the guided portions and are adjacent to both ends in a right-left direction in a front end side on the upper surface of the table, the guide portions being movable in a front-rear direction by guiding drive shafts disposed in the parallel alignment devices, wherein
relative movement of the pair of guide portions in a state where the guide portions and the guided portions are engaged adjusts a parallelism between a predetermined reference plane of the workpiece and a predetermined reference direction of the machine tool.

5. The machine tool according to claim 4, wherein
a guide surface that inclines at a predetermined angle in a right-left direction is formed in the guide portion, and
a guided surface that inclines at a predetermined angle in a right-left direction is disposed in the guided portion in an engageable manner with the guide surface.

6. The machine tool according to claim 4, wherein
when the pallet is changed, the guiding drive shaft separates the guide portion from the guided portion, and moves the guide portion to a retreat position where the guide portion does not interfere with the pallet change.
